(19) United States
(12) Patent Application Publication
(10) Pub. No.: US 2014/0357944 A1
(43) Pub. Date: Dec. 4, 2014

(54) HIGH TORQUE PERSONAL MASSAGER

(71) Applicant: Boulder Applied Physics, Inc., Denver, CO (US)

(72) Inventor: Lafe Spietz, Denver, CO (US)

(73) Assignee: Boulder Applied Physics, Inc., Denver, CO (US)

(21) Appl. No.: 14/292,036

(22) Filed: May 30, 2014

Related U.S. Application Data
(60) Provisional application No. 61/828,772, filed on May 30, 2013.

(51) Int. Cl. A61H 19/00

(52) U.S. Cl. CPC A61H 19/40; A61H 2201/12
USPC 600/38; 601/112

(57) ABSTRACT

A personal massager for sexual stimulation including a rotational drive, a mechanical transformer coupled to the rotational drive and which transforms a rotational output of the rotational drive to provide an output drive shaft having increased torque relative to the rotational output of the rotational drive, a mass coupled off-center to the output drive shaft, and a housing within which the rotational drive, mechanical transformer, and mass are disposed and which includes space for rotational movement of the mass by the output drive shaft, wherein the rotational movement of the mass imparts an oscillating motion to at least a portion of the housing.

### CROSS-REFERENCE TO RELATED APPLICATIONS

This Utility Patent Application is a non-provisional application of U.S. Ser. No. 61/828,772, filed May 30, 2013, which is incorporated herein by reference.

### FIELD OF THE INVENTION

This invention relates to personal massagers for sexual stimulation.

### BACKGROUND OF THE INVENTION

Sexual pleasure and satisfaction have been universally established as promoting physical and mental health as well as harmony within society at large. Both with and without a partner, extensive use of technology has aided significantly in allowing more people to achieve sexual satisfaction. This technology consists of a vast field of sex machines, vibrators, and other sexual aids.

In particular, vibrators have a long and very successful history as sexual massagers. Vibrators typically employ a motor to directly drive a mass off-axis, rigidly fixed inside some kind of housing. The motion of this mass creates a rotating force which produces an oscillating or gyrating motion of the housing and any object with which it is in contact, in particular skin or tissue which is in direct contact with or in mechanical communication with the surface of the housing. The oscillating or gyrating motion against the skin creates a pleasurable sensation for the user, and can be used both to massage muscles and for creating sexual satisfaction.

The clitoris is the primary source of sexual pleasure in the human female. It consists of a mass of tissue inside the body, which is an anatomical homolog to the penis. Popular literature and common perceptions identify the glans of the clitoris as the entirety of the organ. This is not correct. While the glans is the most visible or external portion of the clitoris, there is a significant mass of erectile tissue and sensitive nerves which are attached to interior components of the clitoris, and which are distinct from and larger than the glans.

The directly driven rotating mass employed by conventional vibrators is typically just a few grams. Vibrators employing such a rotating mass provide an amount of force and oscillation that is sufficient for stimulating a mass of tissue approximately equal to that of the rotating mass, such as the glans of the clitoris, for example. However, such vibrators are incapable of providing sufficient stimulation to the larger masses of tissue surrounding the interior parts of the clitoris, and from which considerable sexual pleasure may be derived.

Some products use vibrators of various sizes to drive some type of stimulator attachment, such as a dildo, for example. However, the total mass of the dildo is typically hundreds of grams, while the driven mass inside the vibrator is just a few grams. This leads to a mechanical impedance mismatch and a resulting failure of the vibrator to induce significant motion in the dildo so that such products are similarly incapable of providing sufficient stimulation to larger masses of tissue.

### SUMMARY

A personal massager for sexual stimulation including a rotational drive, a mechanical transformer coupled to the rotational drive and which transforms a rotational output of the rotational drive to provide an output drive shaft having increased torque relative to the rotational output of the rotational drive, a mass coupled off-center to the output drive shaft, and a housing within which the rotational drive, mechanical transformer, and mass are disposed and which includes space for rotational movement of the mass by the output drive shaft, wherein the rotational movement of the mass imparts an oscillating motion to at least a portion of the housing.

By employing a mechanical transformer to increase the torque of the output drive shaft, a personal massager according to the present disclosure provides the rotating mass with a substantially greater force to velocity ratio than that of conventional vibrators and, as result, is able to employ a substantially larger mass than conventional vibrators. According to one embodiment, a rotating mass of up to 500 grams is employed. By employing a larger rotating mass, a personal massager according to the present disclosure transfers more energy and provides more motion to an external object than conventional vibrators and, as a result, can stimulate larger tissue masses than conventional vibrators.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 illustrates an example of a personal massager according to one embodiment.

FIG. 2 illustrates an example of a personal massager according to one embodiment.

FIGS. 3A-D illustrate examples of a personal massager including stimulator attachments according to the present disclosure.

FIGS. 4A-B illustrate accessories for hands-free use of a personal massager according to embodiments of the present disclosure.

FIGS. 5A-C illustrate accessories used to couple mechanical energy to objects or body parts from a personal massager according to embodiments of the present disclosure.

FIGS. 6A-6F illustrate examples of a universal adapter according to one embodiment.

FIG. 7 illustrates an example of a personal massager according to one embodiment.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that the features of the various exemplary embodiments described herein may be combined with each other, unless specifically noted otherwise.

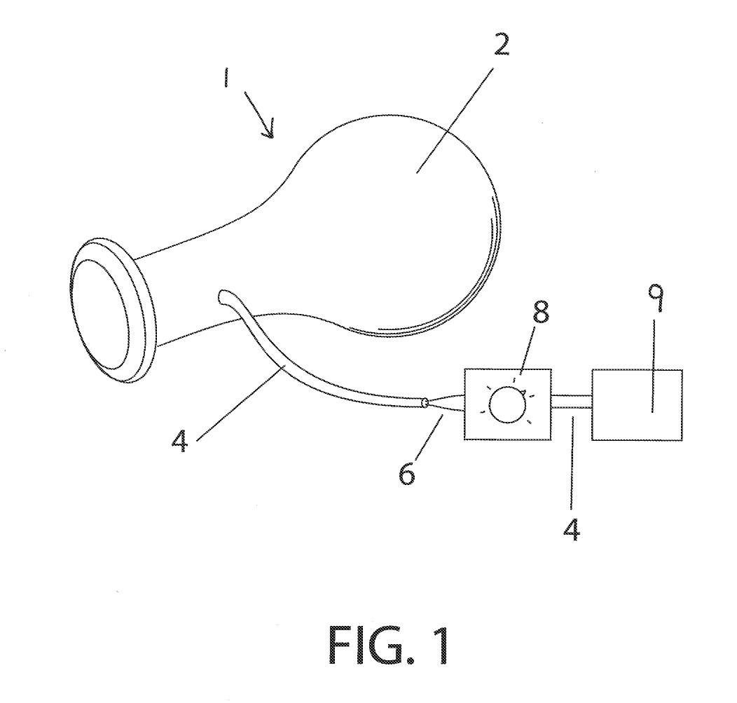

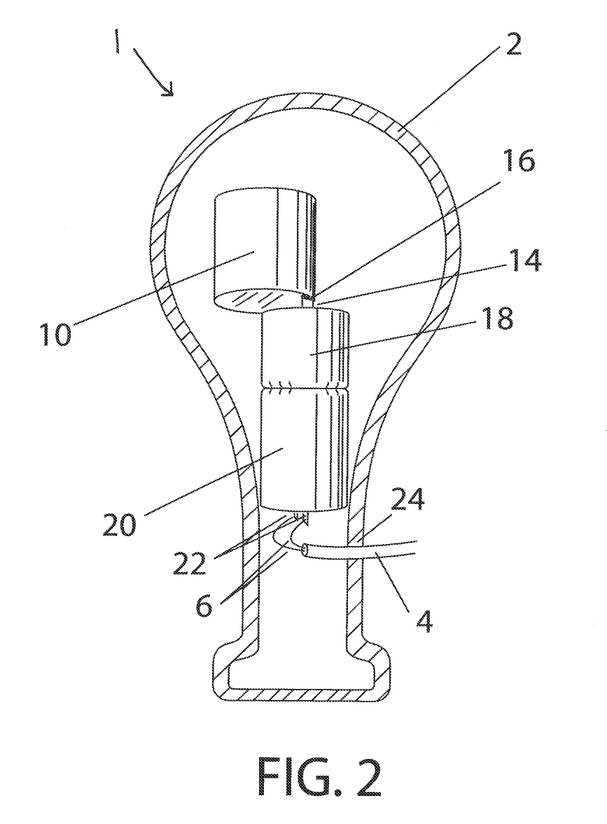

FIG. 1 illustrates a personal massager 1 according to one embodiment. A housing or enclosure 2 contains a mechanical drive system therein (see FIG. 2) and is connected via a power cable 4 to an optional speed control 8 by means of electric wires 6. According to one embodiment, the mechanical drive system includes a speed control and is powered by a power source 9 such as a battery, DC power supply, wall current, solar panel, or other means of generating electrical energy.

A partial sectional view of personal massage 1, according to one embodiment, is shown in FIG. 2. A power cord 4 feeds electrical energy through a hole 24 in the enclosure 2. Power cord 4 includes a pair of electrical wires 6 which are connected to motor 20 via electrical contacts 22. The motor 20 drives a mechanical transformer 18 which increases the torque and decreases the rotational speed from a shaft of motor 20 to an output drive shaft 14. According to one embodiment, mechanical transformer 18 includes a gear box. According to one embodiment, the mechanical transformer 18 for increasing torque may take other forms, such as a belt or chain drive, for example. According to one embodiment, mechanical transformer 18 provides a torque to output drive shaft 14 that is in a range from 10 to 500 times greater than the torque of the shaft of motor 20.

The output drive shaft 14 is coupled by means of a rigid mechanical fixture 16, such as an epoxy or weld joint, for example, to a mass 10, which is coupled off-center or off-axis from output drive shaft 14. According to one embodiment, mass 10 comprises a rigid material, such as steel, lead, aluminum, wood, ceramic, or brass, for example. According to one embodiment, mass 10 is within the range from 10 to 500 grams in mass so as to enable personal massager 1 to effectively stimulate tissue of similar mass within the body. Such a mass 10 is much greater than that of conventional personal massagers, up to 250 times greater, for example.

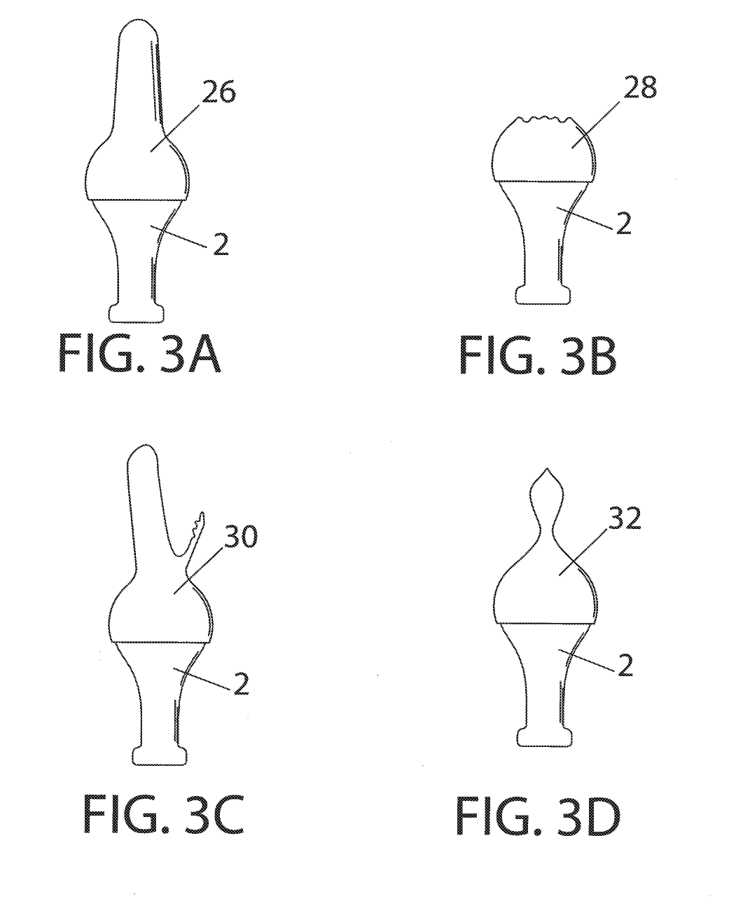

FIGS. 3A to 3D illustrate example embodiments of various stimulator attachments that may be fitted over enclosure 2. In FIG. 3A a dildo attachment 26 is shown. FIG. 3B shows an attachment with a textured surface 28 for external use. FIG. 3C shows arbitrary shapes that could also be used for the attachment 30, and FIG. 3D shows an attachment designed for anal insertion and stimulation 32. These stimulator attachments may either be removable or not. Removability of attachments allows them to be washed separately from the main unit, as well as to be exchanged for one another. It is noted that, according to one embodiment, enclosure 2 and any stimulator attachments are formed of a body-safe silicone material.

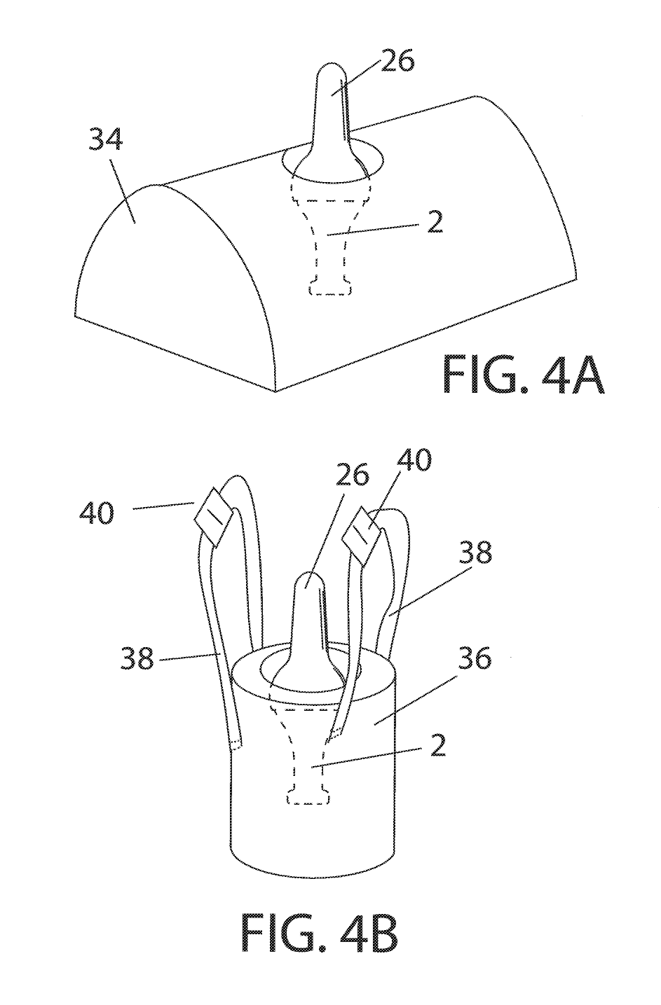

FIGS. 4A and 4B show the means by which the invention may be used without being held by the handle, i.e. “hands free”. FIG. 4A shows an embodiment in which a user may sit or lie on the invention. The enclosure 2 is held in place in a cavity in the block of material on which the user sits 34. While FIG. 4A shows the dildo attachment 26, it could also be the textured attachment 28, the arbitrary shape attachment 30, or the anal attachment 32.

FIG. 4B shows an embodiment of the invention for hands-free use in which the enclosure and attachment are mounted in a fixture 36. This entire assembly is affixed to the user's body by means of leg straps 38, which may be connected or disconnected from the legs by means of buckles or clips 40.

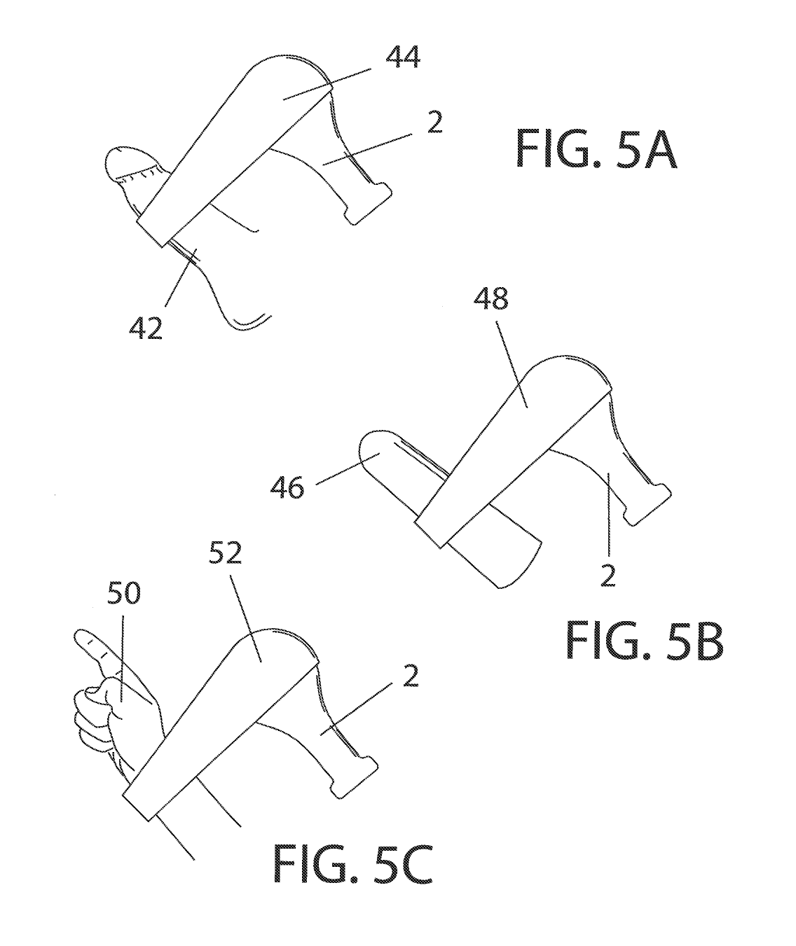

FIG. 5A-C show means of coupling the invention to objects or body parts to which it may impart motion. In FIG. 5A the enclosure 2 is shown coupled via a mechanical coupling unit 44 to a penis 42, which may be caused to oscillate and stimulate another person's genitals. FIG. 5B shows the enclosure 2 coupled via a similar coupling unit 48 to a dildo 46 or other inanimate object. FIG. 5C shows the enclosure 2 coupled via a similar coupling unit 52 to a human hand 50 or inanimate facsimile of a hand.

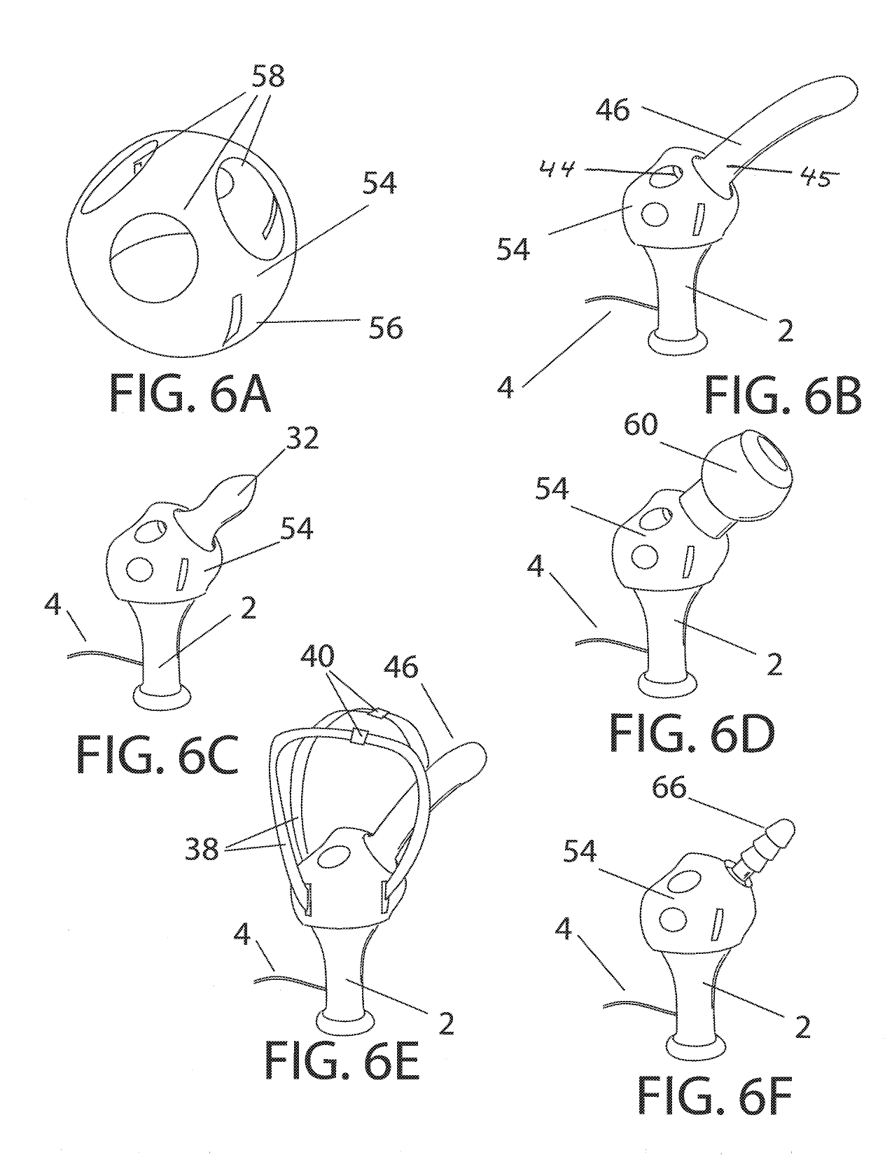

FIG. 6A-6F illustrates a universal adapter 54 that enables the attachment of any number of various types of stimulator attachments, including stimulator attachments manufactured by others and not specifically intended for use with personal massager 1. According to one embodiment, universal adapter 54 fits over the massager enclosure 2 and includes a plurality of holes 58 which are configured to hold any number of various types of stimulator attachments or toys in place, which might include one or more dildos 46, as shown in FIG. 6B. The holes 58 can also be used to hold a butt plug 32, or a penis sleeve 60, as shown in FIGS. 6C and 6D. Additionally slots 56 may be provided for other purposes, such as to facilitate the use of straps. FIG. 6E shows how leg straps can be threaded through the slots 56 of the elastomer universal adapter in order to enable hands-free usage of the device.

Each of the stimulator attachments includes a flared base 44 that is wider than a lengthwise portion 45 extending therefrom. According to one embodiment, a stimulator attachment is fitted through one of holes 58 such that universal adapter 54 secures the flared base 44 against the housing 2, for example, against head portion 2b, with the lengthwise portion 45 extending through the corresponding opening. According to one embodiment, universal adapter 54 comprises an elastic material which is elastic and is configured to be stretched over and secured to head portion 2b, with holes 58 being configured to stretch to receive and snugly fit about an outer surface of a stimulator attachment. According to one embodiment, the holes 58 are of various shapes and sizes and are dispersed over the surface of universal adapter 54. According to one embodiment, universal adapter 54 comprises a body-safe silicone material.

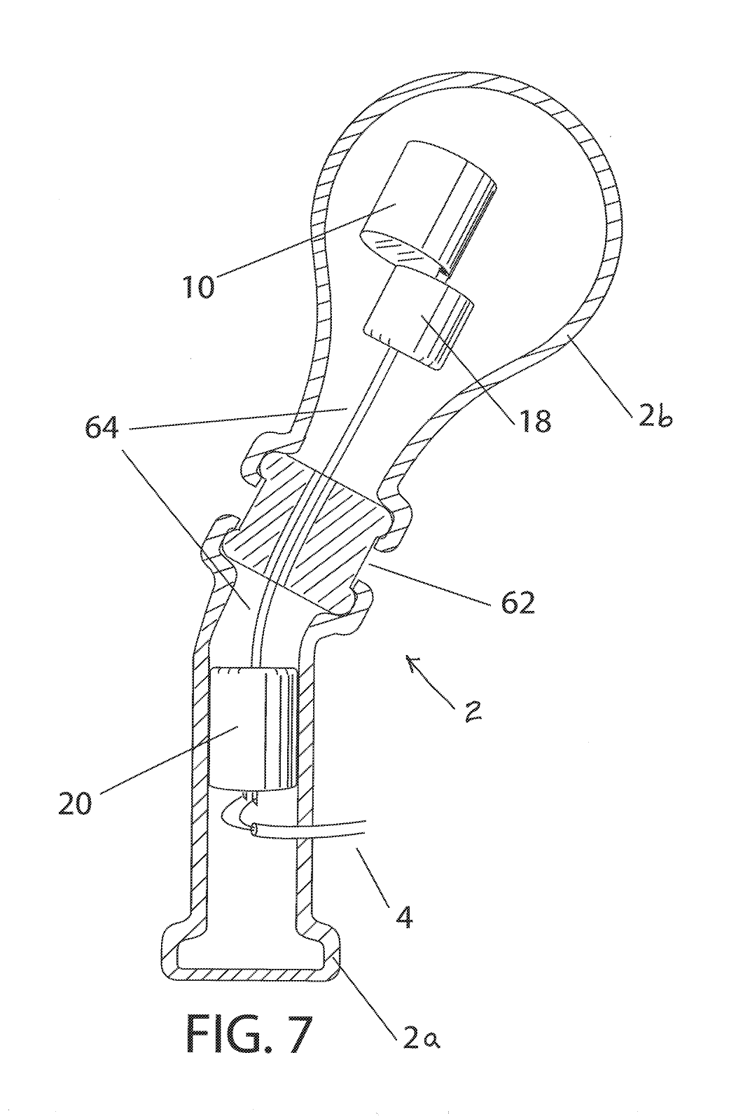

FIG. 7 illustrates one embodiment of personal massager 1 wherein enclosure 2 comprises a separate handle portion 2a and head portion 2b. According to one embodiment, as illustrated, motor 20 is disposed in handle portion 2a and the gear box 18 and mass 10 being disposed in head portion 2b. In other embodiments, the mass 10 is disposed in the head portion 2b, and the gear box 78 and motor 20 are disposed outside the head portion 2b. In one embodiment, the gear box 18 is disposed in the handle portion 2a. A vibration isolating joint 62 separates the handle portion 2a from the head 2b, thereby coupling less vibration into the user's hand and making the device easier and more comfortable to use. In one embodiment, motor shaft 64 is a flexible motor shaft. According to one embodiment, vibration isolating joint 62 comprises a body-safe silicone material.

A vibrator most efficiently couples mechanical energy to a body part or tissue that has approximately the same mass as that of the directly driven rotating mass employed by the vibrator. Conventional vibrators typically employ a rotating mass of only a few grams, which is similar to the mass of the glans of the female clitoris. As a result, the motors and directly driven rotating mass of conventional vibrators are not capable of coupling enough mechanical energy to objects or body parts of larger masses, such as the mass of erectile tissue and sensitive nerves which are attached to interior components of the clitoris.

The utility and benefits of a personal massager according to the present disclosure are described below based on examples of specific implementations of personal massager 1 of FIG. 2.

According to one example implementation, the mass 10 might be a steel cylinder with a volume of 10 cm³, having a mass of 78 grams. If the center of mass is a distance r from the axis of rotation, the angular velocity is ω, the frequency in Hz is f, and the linear velocity of the center of mass is v, then the centripetal acceleration is given by

$$F = \frac{{mv}^{2}}{r} = \frac{m {ω}^{2} {r}^{2}}{r} = mr {ω}^{2} = 4 {π}^{2} {mrf}^{2}$$

Thus for a frequency of 900 revolutions per minute, or 15 Hz, a mass of 78 g, and a displacement r from the axis of 1 cm, the force is 6.9 Newtons, or 1.6 pounds of force. The mass in a conventional vibrator without a mechanical transformer to increase torque is limited by the intrinsic maximum load of the motor, and is typically just a few grams, or about a factor of 10 or more smaller than in a personal massager according to the present disclosure, such as personal massager 1 of FIG. 2. However, based on the above equation, in order to apply force to the body equivalent to that of the above example implementation of personal massager 1, a conventional vibrator would require a speed that is 100 times higher than that of the example implementation, meaning that a conventional vibrator has a force to velocity ratio that is 100 times lower than that of the example implementation.

This ratio of force to velocity, called the “mechanical impedance”, determines how efficiently energy may be coupled between physical objects. To take an analogy from sports, one may compare the sports of badminton and bowling. In bowling a massive ball (perhaps 6 kg) is accelerated efficiently by the human arm, which is also a few kg in mass. In badminton, a small, thin, racket is used to accelerate a shuttlecock, which is typically just a few grams in mass. If the same athlete who efficiently rolls a bowling ball with their arm or swings a racket to hit a shuttlecock were to swing the badminton racket against the bowling ball, the results would be qualitatively different. The racket would get destroyed by the force and induce almost no velocity in the ball, even with the same exact force or power available from the human arm.

The above analogy clearly illustrates the benefits of employing a mechanical transformer, according to embodiments of a personal massager of the present disclosure, to achieve a greater force to velocity ratio. If a vibrator is to stimulate the larger masses of tissue deep inside the body, which can have more than 100 times higher mass than the surface tissue which constitutes the glans of the clitoris, use of a personal massager or vibrator having over 100 times higher force to velocity ratio than conventional vibrators constitutes a significant qualitative and quantitative improvement. The increased efficiency of coupling mechanical energy from the personal massager to a body part means that a smaller motor is required to stimulate tissue deep inside the body than is the case for conventional, large vibrating machines capable of achieving such stimulation (e.g. a Sybian©, which employs are large motor and direct drive vibrating mechanism). It also enable users to specifically target certain areas (e.g. internal clitoral tissue) without over-stimulating the external areas. Personal massager 1 can also be used in conjunction with a separate, conventional, lower-mass vibrator which stimulates the external tissue, while personal massager 1 stimulates the internal tissue.

In view of the above, a personal massager employing a mechanical transformer according to the present disclosure, such as personal massager 1 of FIG. 2, is able to achieve a greatly increased force to velocity ratio than that of conventional vibrators. As a result, a personal massager according to the present disclosure is able to employ an off-center mass which is much larger than that of conventional vibrators and, as a result, is able to stimulate much larger masses than conventional vibrators. According to one example, personal massager 1 has a force to velocity ratio (i.e. a mechanical impedance) of not less than 1 kg/s (kilograms per second). According to one example, personal massager 1 has a force to velocity ratio of up to 20 kg/s.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A personal massager for sexual stimulation comprising:
a rotational drive;
a mechanical transformer coupled to the rotational drive and which transforms a rotational output of the rotational drive to provide an output drive shaft having increased torque relative to the rotational output of the rotational drive;
a mass coupled off-center to the output drive shaft; and
a housing within which the rotational drive, mechanical transformer, and mass are disposed and which includes space for rotational movement of the mass by the output drive shaft, wherein the rotational movement of the mass imparts an oscillating motion to at least a portion of the housing.

2. The personal massager of claim 1, wherein the rotational drive comprises an electric motor and the rotational output comprises a rotating shaft of the motor, wherein the mechanical transformer provides the output shaft with an increased torque and a decreased speed relative to the motor shaft.

3. The personal massager of claim 1, wherein the mechanical transformer comprises a gear box.

4. The personal massager of claim 1, wherein the mass is in a range from 10 to 500 grams.

5. The personal massager of claim 1, wherein the rotating mass has a mechanical impedance in a range from 1 kg/s to 20 kg/s.

6. The personal massager of claim 1, wherein the housing has a handle portion for gripping and a head portion, wherein at least the mechanical transformer and mass are disposed within the head portion, and wherein rotational movement of the mass imparts the oscillating motion to at least the head portion.

7. The personal massager of claim 6, wherein the handle portion is separated from the head portion of the housing by a vibration isolator.

8. The massager of claim 6, including a stimulation attachment selectively coupled to the head portion of the housing.

9. The personal massager of claim 8, wherein the attachment mechanically transfers the motion of the housing to an object or appendage of the human body such that the object or appendage can further transmit the motion to a human body for sexual stimulation.

10. A personal massager for sexual stimulation comprising:
a housing having a head portion and a handle portion, wherein the head portion is coupled to the handle portion with a vibration isolating joint;
a rotational drive rotating an off-center mass, wherein the rotational drive and off-center mass are disposed within the housing with at least the off-center mass being disposed in the head portion, wherein rotation of the off-center mass imparts movement to the head portion and the vibration isolating joint reduces transmission of such movement to the handle portion.

11. The personal massager of claim 10, wherein the vibration isolating joint comprises a vibration dampening media.

12. The personal massager of claim 11, wherein the vibration isolation joint comprises an elastic material.

13. The personal massager of claim 11, wherein the vibration isolation joint comprises a body-safe silicon material.

14. The personal massager of claim 11, wherein the vibration isolation joint comprises a neoprene material.

15. The personal massager of claim 11, wherein the rotational drive comprises an electric motor, wherein the mechanical transformer transforms a rotational output of the electric motor to provide an output drive shaft having increased torque relative to the rotational output of the electric motor, wherein the mass is coupled off-center to the output drive shaft, and wherein the mechanical transformer and mass are disposed in the head portion and the electric motor is disposed in the handle portion.

16. A personal massager for sexual stimulation comprising:
a housing;
an electric motor rotating an off-center mass, wherein the electric motor and mass disposed within the housing, and wherein rotation of the off-center mass imparts an oscillating movement to at least a portion of the housing; and
a universal adapter configured to slideably fit over at least the oscillating portion of the housing, the universal adapter a plurality of openings extending there through, wherein each opening is configured to slideably receive any of a number of types of stimulation devices having a flared base that is wider than a lengthwise portion extending there from, and wherein the universal adapter secures the flared base against the housing with the lengthwise portion extending through the opening.

17. The personal massager of claim 16, wherein the universal adapter comprises an elastic sleeve.

18. The personal massager of claim 16, wherein the plurality of openings are of different sizes and are dispersed about the universal adapter so that the stimulation devices can be coupled at different positions and angles relative to the housing.

19. The personal massager of claim 16, wherein the housing has a handle portion and a bulbous head portion, and wherein the universal adapter is configured to slide over the bulbous head portion.

20. The personal massager of claim 17, further including a pair straps for securing the personal massager to a user's body to enable hands-free use, wherein the universal adapter includes a first pair of slots and a second pair of slots positioned so as to be disposed on opposing sides of the bulbous head portion, wherein a first one of the pair of straps extends through the first pair of slots and around the opposing side of the housing below the bulbous head, and wherein a second one of the pair of straps extends through the second pair of slots and around the oppsosing side of the housing below the bulbous head.
